(19) United States
(12) Patent Application Publication
(10) Pub. No.: US 2026/0255447 A1
(43) Pub. Date: Aug. 27, 2026

(54) POLYMER ARTICLES INCLUDING TEMPERATURE CONDITIONING ELEMENTS AND METHODS FOR SAME

(71) Applicant: Bedford Industries, Worthington, MN (US)

(72) Inventors: Jay Alan Milbrandt, Worthington, MN (US); Colin Martin O'Donnell, Worthington, MN (US)

(21) Appl. No.: 19/545,944

(22) Filed: Feb. 20, 2026

Related U.S. Application Data
(60) Provisional application No. 63/761,673, filed on Feb. 21, 2025.

(51) Int. Cl. H05B 3/28; H05B 3/14; H05B 3/18

(52) U.S. Cl. CPC H05B 3/286; H05B 3/14; H05B 3/18; H05B 2203/017; H05B 2203/026

(57) ABSTRACT

An example polymer board assembly can include a polymer board. The polymer board can include, for example, an interior portion and one or more exterior side portions surrounding the interior portion. At least one heating element can include, for example, at least one electrical connection portion and the at least one heating element at least partially positioned within the interior portion. Optionally, the at least one heating element extends within the interior portion.

### CLAIM FOR PRIORITY

This application claims the benefit of priority of U.S. Provisional Application No. 63/761,673, filed Feb. 21, 2025, which is incorporated by reference in its entirety.

### TECHNICAL FIELD

This document pertains generally, but not by way of limitation, to polymer articles including heating elements.

### BACKGROUND

Outdoor structures, flooring, or the like are, in various examples, formed with lumber, composites or polymer-based materials. For example, products such as decks, patios, walkways, railings, fences, furniture, components thereof, or the like are constructed from boards, slats, strips, planks, panels, beams, or the like (hereinafter “article” or “articles”). In some examples, the products include boards that are components of furnishings such as benches, chairs, tables, or the like.

In some environments, the products include structures or assemblies. Products or assemblies can include components that when assembled, form flooring, furniture, or the like that can be exposed to weather conditions. At times, the weather conditions can include temperatures close to or below the freezing point of water (e.g., snow, ice, rain, or the like). In such conditions, the articles are prone to accumulating snow or ice.

In some environments, the products include structures or assemblies that can be used indoors. The components, when assembled, can form structures, flooring, furniture, or the like, that can be used indoors (or outdoors) in environments subject to cold temperatures (e.g., ice rinks, walkways proximate ice rinks, seating, stairs, flooring, or the like).

### SUMMARY

In an example, a polymer article assembly can include a polymer article having an interior portion and one or more exterior side portions surrounding the interior portion. At least one heating element can include at least one electrical connection portion that can be at least partially positioned within the interior portion. The at least one heating element can extend from the electrical connection portion within the interior portion of the polymer article. The at least one heating element can conduct heat through at least one of the one or more exterior side portions to increase a surface temperature. The polymer article can include an engagement side and a base side opposed to the engagement side. The at least one heating element can be positioned within the interior portion closer to the engagement side than to the base side. The polymer article can include one or more recesses, and the at least one heating element can be positioned within the one or more recesses. A polymer overlay can be coupled with the polymer article and configured to cover the one or more heating elements.

In an example, a temperature-controlled polymer article assembly can include a base board including an engagement side and a base side. A polymer overlay can be coupled along the engagement side of the base board and can include an engagement face and a coupling face. One or more heating elements can be positioned relative to the polymer overlay and can include at least one electrical connection portion configured to be electrically coupled with an electrical source. The one or more heating elements can be positioned within the polymer overlay, can extend through the polymer overlay, or can be positioned between the polymer overlay and the engagement side of the base board. An intermediate layer can be positioned between the engagement side and the coupling face, and the one or more heating elements can be positioned within the intermediate layer. The polymer article can be a component of an article of furniture or a linearly extending component of flooring or decking.

In an example, a method of forming a temperature-conditioned polymer article can include positioning one or more temperature-conditioning elements along a cavity defined by portions of a mold, retaining the one or more temperature-conditioning elements at a first end position, introducing molten polymer into the cavity, covering the one or more temperature-conditioning elements with the molten polymer, and retaining the one or more temperature-conditioning elements within a set polymer. A method of forming a temperature-conditioned polymer board can include forming a polymer board including an engagement side and a base side, forming one or more recesses within the polymer board proximate to the engagement side, and positioning one or more heating elements within the one or more recesses. The method can include drilling one or more passages through at least a portion of the polymer board and coupling a polymer overlay on the polymer board.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1A is an example of a schematic of cross section of a polymer article assembly including one or more heating elements.

FIG. 1B is an example of a perspective view of a schematic of a polymer article assembly including one or more heating elements.

FIG. 2 is another example of a schematic of cross section of a polymer article assembly including one or more heating elements.

FIG. 3 is an example of a schematic of cross section of a board article including a polymer overlay including one or more heating elements.

FIG. 4 is another example of a schematic of cross section of an article assembly including a polymer overlay including one or more heating elements.

FIG. 5A-5C are examples of a method of forming an article assembly including a polymer overlay including one or more heating elements.

### DETAILED DESCRIPTION

Outdoor structures, such as decks, patios, walkways, stairs, railing, or the like are constructed using materials such as lumber, composites, metals, stone, or polymers. In other examples, materials such as lumber, composites, metals, stone, or polymers are used to in the construction of furniture, indoor structures, walkways, railings, stairs, or the like. Use of these materials, while durable, can face challenges when exposed to varying weather or temperature conditions, particularly in colder climates. For example, surfaces used in these structures may accumulate snow and ice that, at times, leads to safety hazards such as reduced traction. In other examples, in cold environments, these surfaces become undesirable for contact, as seen in outdoor furniture or seating areas.

At times, management of indoor or outdoor structures exposed to cold weather or cold temperature conditions can be inadequate. For instance, lumber, metal, stone, composite, or polymer materials used for structures do not effectively address maintaining surface conditions, such as traction. In other examples, use of lumber, composite, stone, metal, or polymer materials do not address comfort for a user in cold weather situations. Some methods to address comfort in cold environmental conditions can include removal of snow and ice. In other examples, external heating devices are used; however, these devices can be cumbersome or inefficient. A more integrated and efficient approach to temperature control of surfaces used in outdoor and indoor environments, such as those exposed to cold temperatures, can result in desired conditions.

A problem to be solved can include providing a surface that at least partially maintains traction or comfort when subject to environmental conditions that inhibit traction or have undesired surface temperatures. The surface of the article or structures that can be exposed to cold environments can be undesirable or uncomfortable to a user. In other examples, members weather conditions such as snow, ice, sleet, freezing rain, or the like, at times, reduce traction of the articles. For example, a problem to be solved can include increasing the surface temperature of an article in environments with temperatures proximate to or below the freezing point for water. In other examples, a problem to be solved can include adjusting the surface temperature to enhance the comfort or usability of the article, such as a board, when the article is in use. For instance, components such as boards used in benches, flooring, railings, steps, or similar structures are frequently subjected to cold environments, including conditions near or below the freezing point of water, or temperatures lower than 10 degrees Celsius.

In other examples, a temperature-altering element can be installed within, or along, an overlay to alter the temperature of the overlay. The overlay can be installed along a base board. When discussing a board (or boards) herein the board can include, but is not limited to, outdoor and indoor flooring, such as slats, panels, or beams. Boards can also include one or more strips or the like for a deck, porch, room, or walkway. The board can further include structural or decorative slats, strips, panels, or the like that can be one or more components of furnishing.

A board overlay can include a protective shell or layer for the base board. The board overlay can optionally change the appearance of the board. For example, the board overlay can cover one or more boards (e.g., panels, beams, strips, or the like) of a porch, deck, floor, walkway, railing, or the like. In other examples, the board overlay can be applied to, or cover, boards of a bench, chair, stool, table, furniture, or the like. The board overlay, in some examples, can include but is not limited to, a covering, wrap, jacket, drape or the like that is complementary to the profile of a board and envelopes at least a portion of the board.

The board overlay can be coupled with the base board, and the board overlay can include heating elements. For example, the heating element can include one or more heating elements coupled with the base board. For instance, the conditioning elements are embedded within or coupled along a surface of the polymer article, overlay, or the like. The one or more heating elements can alter the surface temperature of the polymer article, overlay or the like. The heating elements can be electrified to radiate heat, or conductively heat, to increase the temperature of at least an exterior portion of the polymer article, the overlay, or the like.

In examples, temperature conditioning elements are used to alter the temperature, either with heating or cooling. While heating elements are discussed herein, other temperature conditioning methods or components are contemplated. For example, heating elements are coupled with or positioned relative to an article or component of an article (e.g., boards, slats, strips, planks, panels, beams, or the like). The heating elements can extend within the article (hereinafter article also refers to components of an article as well). The heating elements can be positioned relative to the article. For instance, the heating elements can extend relative to an overlay (e.g., board overlay). In yet other examples, the heating elements can extend relative to an intermediary layer, such as an insulative layer, positioned between a board and an overlay.

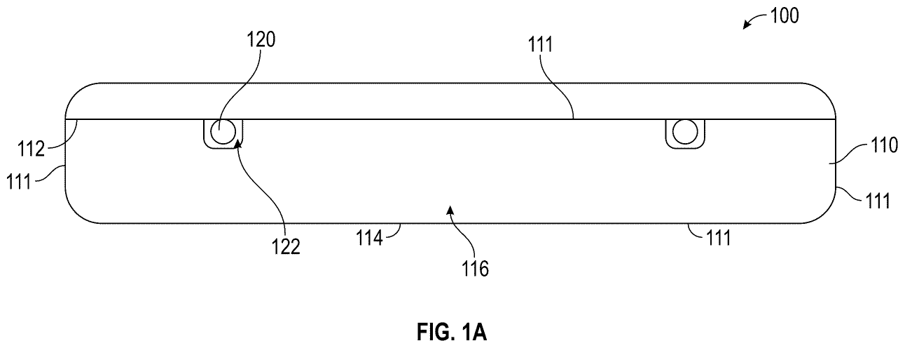

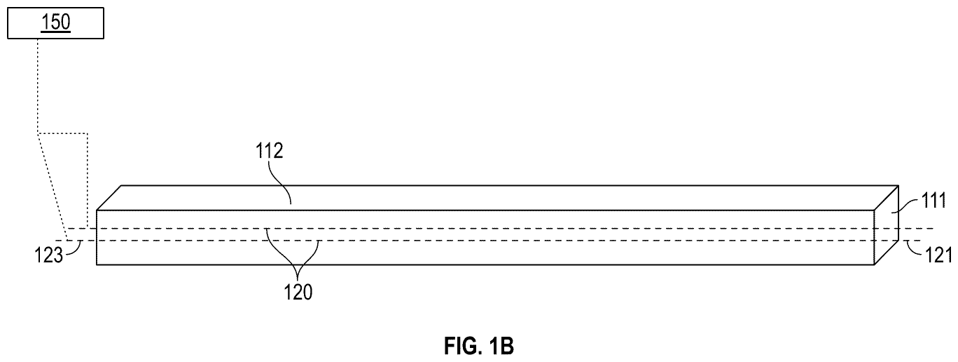

Illustrated in FIG. 1A is cross section of an example of an article assembly 100. The article assembly 100 can include an article 110 (e.g., board, slat, strip, plank, panel, beam, or the like). The article 110 is, in some examples, a board (e.g., slat, strip, plank, panel, beam, or the like) formed from lumber, composite material, metal, concrete, or a naturally occurring material. In other examples, the article 110 can include a polymer board. The article 110 can include, for example, one or more exterior side portions 111. The side portions 111 include, for example, an engagement side 112 and an opposed side as a base side 114. The engagement side 112 is, for instance, a side of the article 110 that is in contact with a user. For instance, the engagement side 112 is a side of the one or more exterior side portions 111 that engages with a user, such as the walkway of flooring or seat of an article of furniture. The base side 114 is the one or more exterior side portions 111 that is in communication with, for example, a foundation, ground, or the like. In other examples, the base side 114 is a side of the one or more exterior side portions 111 that is an underside, such as the underside of a bench or other article of furniture or structure.

The one or more exterior side portions 111 surround an interior portion 116 of the article 110. For instance, the interior portion 116 is solid. In other examples, the interior portion 116 is a foamed material. In yet other examples, the interior portion 116 can include one or more recesses 122, cavities, openings, or the like. Optionally, the interior portion 116 can include one or more recesses 122 (e.g., cavities, openings, or the like) that extend at least partially along the interior portion 116.

In some examples, the one or more recesses 122 extend along the article 110. The one or more recesses 122 are optionally positioned within the interior portion 116. In another example, the one or more recesses 122 are positioned relative to the engagement side 112 of the article 110. The one or more recesses 122 are formed, for example, to retain additional components of the article assembly 100.

In some examples the article assembly 100 is a temperature-controlled board system. For instance, additional components of the article assembly 100 include one or more temperature conditioning elements, such as one or more heating elements 120. The article assembly 100 can include one or more heating elements 120 extending through at least a portion of an interior portion 116 of the article 110. In examples, one or more heating elements 120 are positioned proximate to the engagement side 112 of the article 110. For instance, the one or more heating elements 120 are in an exposed position from the engagement side 112 of the article 110. In another example, the one or more heating elements 120 can extend within the interior portion 116 of the article 110. In yet other examples, the one or more heating elements 120 extend along one or more recesses 122 of the article 110.

As illustrated in FIG. 1B, the one or more heating elements 120 can include wires, filaments, strips, tubes, or the like that extend relative to the article 110. For instance, the one or more heating elements 120 can include heating elements as wires that extend through the interior portion 116 of the article 110. The one or more heating elements 120 extend, for instance from a first end 121 to a second end 123. Optionally, the first end 121 and the second end 123 extend out of the article 110. For instance, the first end 121 and the second end 123 extend out of, or exposed from, one or more exterior side portions 111 of the article 110.

The first end 121 or the second end 123 are, for instance, coupled with a heat source, such as a source of electricity 150. The source of electricity 150 provides an electrical current to the one or more heating elements 120, as heating elements. As the current passes through the one or more heating elements 120, heat radiates from the one or more heating elements 120 and away from the one or more heating elements 120. In another example, as current passes through the one or more heating elements 120, heat is conducted through the interior portion 116 of the article 110 to the engagement side 112. The heat transmitted from the one or more heating elements 120 increases the temperature of, for example, the engagement side 112.

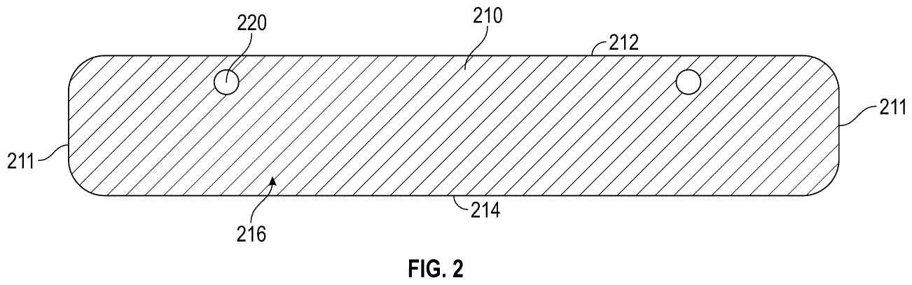

Illustrated in FIG. 2 is another example of a board (e.g., slat, strip, plank, panel, beam, or the like) as a polymer article 210. The polymer article 210 is formed from one or more of High-Density Polyethylene (HDPE), Low Density Polyethylene (LDPE) or polypropylene, or the like. In some examples, the polymer article 210 is formed from a molding process such as injection molding, extrusion molding, pultrusion, blow molding, or the like. The polymer article 210 can include, for example, an engagement side 212 and a base side 214 opposing the engagement side. In examples, the polymer article 210 is formed in a polygonal shape, such as a rectangular prism. The polygonal shape of polymer article 210 can include one or more side portions 211. The one or more side portions 211 optionally connect the engagement side 212 with the base side 214. The engagement side 212, for example, is the surface that a user would contact. The engagement side 212 is, for instance, the surface that benefits from an increase, or change, in temperature.

One or more temperature conditioning elements such as one or more heating elements 220, for example, are formed within the polymer article 210 to change the temperature of the engagement side 212. In examples, the polymer article 210 is formed with heating elements 220 (temperatures conditioning elements) extending along the interior portion 216. The heating elements 220 are positioned within the interior portion 216, for instance, proximate to the engagement side 212. For example, there is a greater volume of polymer material between the heating elements 220 and the base side 214 than the heating elements 220 and the engagement side 212. Positioning the heating elements 220 proximate to the engagement side 212, for instance, provides more heat to the engagement side 212 than when positioned more proximate to the base side 214. In some examples, the heating elements 220 is positioned closer to a central portion of the polymer article 210.

In some examples, there are at least two of the heating elements 220 positioned within the polymer article 210. In some situations, each of the heating elements 220 are equally spaced from the other of the heating elements 220. In other situations, each of the heating elements 220 are positioned within the polymer article 210 along specified locations. For example, one of the heating elements 220 is positioned closer to one of the one or more side portions 211 than another heating elements 220 is positioned relative to an opposite of the one or more side portions 211. In some other examples, there are multiple heating elements 220 positioned within the polymer article 210 according to the purpose.

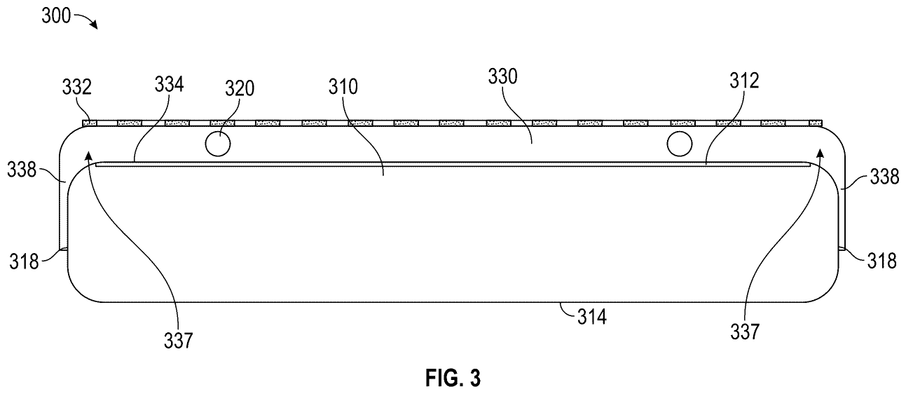

Illustrated in FIG. 3 is another example of providing temperature conditioning to an article assembly 300, such as a temperature-controlled board system. In the example of FIG. 3, heating elements 320, such as one or more of the heating elements 320, are positioned relative to a board 310 (e.g., slat, strip, plank, panel, beam, or the like). The board 310 is formed from, for example, a naturally occurring material such as lumber, stone or the like, or a metal, or a polymer. The board 310, for instance, is a component of a flooring system (e.g., decking, patio, walkway, interior flooring, or the like). In other examples the board 310 is a component of a structure such as a deck, stairway, railing, or the like. In yet other examples, the board 310 is a component of an article of furniture such as a chair, bench, table, or the like.

The board 310 can include a base side 314 that is, for instance, the portion of the board 310 that contacts the ground. In other examples, the base side 314 is an underside of the board 310. The board 310 can include an engagement side 312. The engagement side 312, for example, is the portion of the board 310 that faces the exterior. The engagement side 312 is, for instance, an opposite side of the board 310 to the base side 314.

The board 310 is at least partially covered with a polymer overlay 330. The polymer overlay 330 is, for example, an elongate polymer article. For instance, the polymer overlay 330 can include a linearly extending component. For instance, the polymer overlay 330 is a panel, strip, layer, or the like formed from a polymer material. In some examples, the polymer overlay 330 is formed from pliable components. For instance, the polymer overlay 330 can include an engagement face 332 and a coupling face 334. The engagement face 332 faces the exterior and, for example, is a portion of the polymer overlay 330 that a user interacts with. For example, the engagement face 332 is a portion of the polymer overlay 330 that a user walks on or sits on, in the example of a walkway or a bench.

In examples, the polymer overlay 330 is in communication with the board 310 (e.g., slat, strip, plank, panel, beam, or the like). For example, the polymer overlay 330 is coupled along the surfaces of the board 310. The coupling face 334 is, for example, a portion of the polymer overlay 330 that is opposite from the engagement face 332. In an example, the polymer overlay 330 can include one or more overlay drapes 338 that extend from side portions 337 of the polymer overlay 330. For instance, the each of the one or more overlay drapes 338 extends from the side portions 337 and engages with a board side portion 318.

Positioned relative to the polymer overlay 330 is a heating element 320, as a temperature conditioning component. In examples, there can be one or more of the heating elements 320 positioned relative to the polymer overlay 330. For instance, the heating elements 320 are positioned within the polymer overlay 330. The polymer overlay 330, for example, encases the heating elements 320. In another example at least a portion of the heating elements 320 is exposed from the polymer overlay 330. Optionally, the heating elements 320 extend through a through-hole, recess, cavity, or the like, formed within the polymer overlay 330.

For example, the polymer overlay 330 is couple to the board 310. The coupling face 334 is formed to be coupled with the engagement side 312 of the board 310. In examples, the coupling face 334 is formed to be coupled along the engagement side 312 of the board 310. Optionally, the polymer overlay 330 is coupled with at least a portion of the board 310. In some examples, the one or more overlay drapes 338 can be positioned and coupled with at least one of the board side portions 318.

The polymer overlay 330 can include heating elements 320 that alter the temperature of, for example, the engagement face 332. In some examples, the heating elements 320 are heating elements. The heating elements 320 as heating elements increase the temperature of the engagement face 332 compared to an initial temperature of the engagement face 332.

The heating elements 320 as heating elements are, for example, wires, strips, or the like. The heating elements 320 as heating elements are formed from a conductive material. The conductive material, for instance, radiates heat or conducts heat when electricity passes through or is transmitted through the heating elements 320, as a heating element. The heating elements 320 is, for example, connected to an external source of electricity. As electricity passes through the heating elements 320, heat radiates from the heating elements 320 towards or is in conductive relationship with, for example, the engagement face 332.

In examples, heating the engagement face 332 is beneficial to a user's experience. For instance, the polymer overlay 330 is positioned and coupled over a board 310 as a deck floorboard. In cold weather situations, ice or snow sometimes accumulates on deck floorboards. Increasing the temperature of the heating elements 320 within the polymer overlay 330, at times, minimizes ice or snow accumulating on the deck floorboards.

In other examples, heating the engagement face 332 is beneficial to a user's experience when the polymer overlay 330 is coupled with a board 310 that is a component of an article of furniture such as a bench seat. For instance, supplying electricity to the heating elements 320, as heating elements, increases the temperature of the engagement face 332. In examples, increasing the temperature of the engagement face 332 as a component of a bench seat benefits a user by having a warm seat, as compared to ambient temperatures.

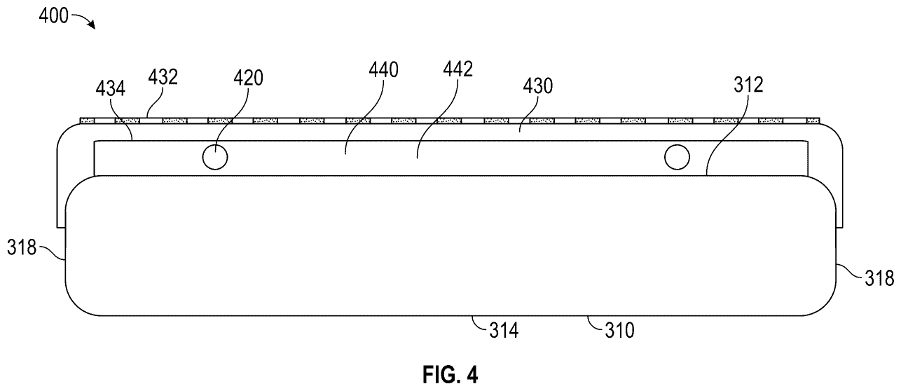

FIG. 4 illustrates an article assembly 400 including the board 310, as described related to FIG. 3, an intermediate layer 440 and a polymer overlay 430. Optionally, the polymer overlay 430 is similar to the polymer overlay discussed related to FIG. 3. The polymer overlay 430 is, for example, coupled with at least the intermediate layer 440. In examples, the intermediate layer 440 is coupled with the board 310. For instance, the intermediate layer 440 is coupled on one side with the engagement side 312 of the board 310 and a coupling face 434 of the polymer overlay 430. The coupling face 434 is, for example, the face of the polymer overlay 430 that is opposite to an engagement face 432. The engagement face 432 is similar to the engagement face discussed related to FIG. 3.

The intermediate layer 440 is, for instance, at least one of an adhesive material, an insulative material, or a conductive material, or other functional material. In another example, the intermediate layer 440 is a foam insulator. In yet another example, the intermediate layer 440 is a polymer insulative layer. Optionally, the intermediate layer 440 is a fiberglass layer. In some examples, the intermediate layer 440 can include at least two layers with one layer formed to conduct heat to the polymer overlay 430 and the other to reduce waste heat to a board, such as board 310.

In an example, the intermediate layer 440 can include one or more heating elements 420. For example, one or more heating elements 420 extend along a core portion 442 of the intermediate layer 440. The one or more heating elements 420 for example are formed within the core portion 442. In another example, the one or more heating elements 420 are positioned within a through-hole, cavity or recess formed through or along the intermediate layer 440.

For instance, the one or more heating elements 420 are positioned along the intermediate layer 440 to radiate or conductively transfer heat towards the polymer overlay 430. For example, the one or more heating elements 420 are positioned along or within the intermediate layer 440 proximate to the polymer overlay 430.

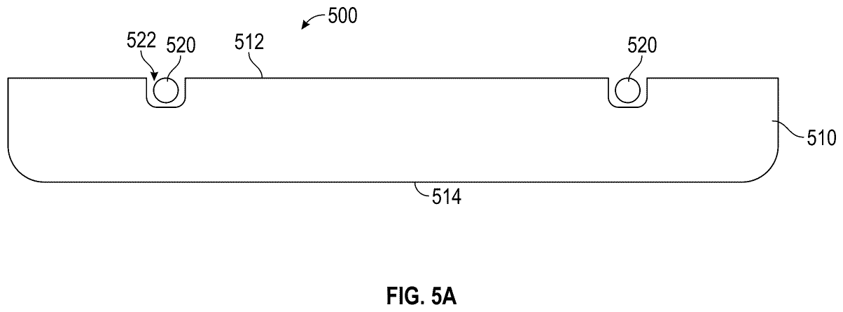

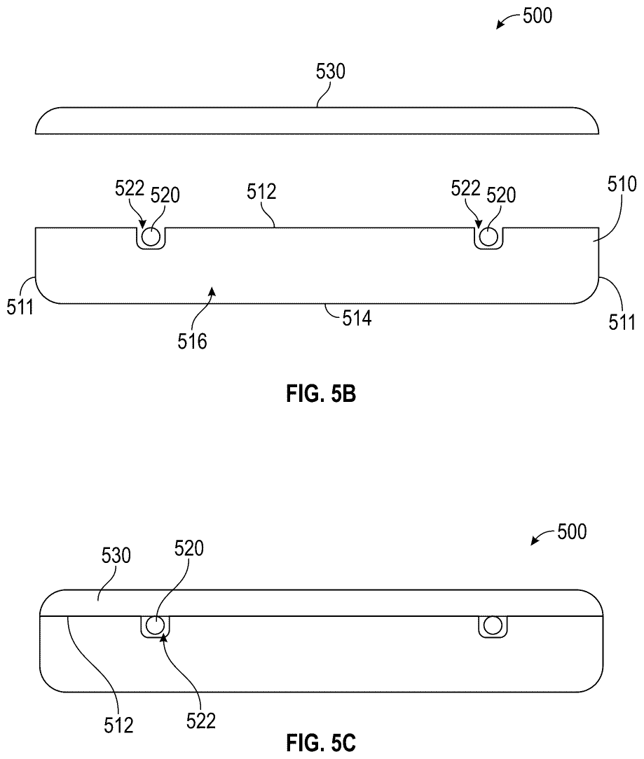

Illustrated in FIGS. 5A to 5C, is an example of forming a polymer article assembly 500. For example, FIGS. 5A to 5C is an example of a method of forming a temperature-conditioned polymer article. For example, the polymer article assembly 500 can include a polymer board 510 (e.g., slat, strip, plank, panel, beam, or the like) with one or more temperature 520. The polymer board, in some examples, is molded into a form that can include at least an engagement side 512 and a base side 514. The engagement side 512 and the base side 514, as well as one or more side portions 511 surround an interior portion 516. The polymer board 510 is formed with a molding process such as extrusion, pultrusion, injection or the like. For instance, a molten polymer is introduced into a mold and allowed to cool or set.

For instance, a molten polymer is introduced into the mold and fills a cavity defined by the mold. In some examples, the polymer board 510 is formed within a mold that can include one or more protrusions. For example, the one or more protrusions in the mold correspond to one or more recess that is to be formed in the polymer board 510. For instance, one or more recesses 522 are formed to extend along the polymer board 510. In examples, the one or more recesses 522 are formed relative to the engagement side 512 of the polymer board 510. The one or more recesses 522, in examples, extends from proximate to the engagement side 512 and towards the interior portion 516. The polymer board 510, for example, is molded to include one or more recesses 522 (e.g., cavity, opening, through-hole or the like). In another example, the one or more recesses 522 is formed by drilling a passage such as the one or more recesses 522 through an interior portion 516 of the polymer board 510. The one or more recesses 522 for example, extend from a first end portion of the polymer board 510 towards a second end portion of the polymer board (for example, as illustrated and discussed related to FIG. 1B).

In examples, the one or more recesses 522 extend longitudinally along the polymer board 510. In one instance, the one or more recesses 522 can extend laterally along the polymer board 510. Optionally, the one or more recesses 522 extends both longitudinally and laterally. For example, the one or more recesses 522 extends in a zig-zag pattern along the polymer board 510.

In some instances, the polymer article assembly 500 can include a heated, or temperature controlled, board system. For example, a temperature-conditioning element can include a heating element 520 is positioned within the one or more recesses 522. For example, one or more of the one or more heating elements 520 can be positioned along, or within, the one or more recesses 522. The one or more heating elements 520 is, for example, a wire or strip positioned within the one or more recesses 522. In examples, the one or more heating elements 520 is a heating element. For instance, the one or more heating elements 520 as a heating element is positioned within the one or more recesses 522 to radiate heat from the wire towards the engagement side 512. In another example, the one or more heating elements 520 as a heating element is positioned within the one or more recesses 522 conducts heat from the wire to the engagement side 512.

Optionally, the one or more recesses 522 are filled with a thermally conductive material, such as a thermally conductive epoxy or the like. For example, the thermally conductive material can be deposited in the one or more recesses 522 to at least partially surround the one or more heating elements 520. The thermally conductive material, for instance, embeds the one or more heating elements 520 within the polymer board 510 and promotes heat flow to the rest of the board. In some examples, including a thermally conductive material promotes even heating of the polymer board 510.

Illustrated in FIGS. 5B and 5C is an example is a polymer overlay 530. The polymer overlay 530 is positioned relative to the polymer board 510 to cover the one or more heating elements 520 (temperature conditioning element). For example, the polymer overlay 530 in an example is similar to the polymer overlay discussed related to FIGS. 3 and 4. In other examples, the polymer overlay 530 is another polymer component that is formed to cover (e.g., completely cover, cover 90 percent, cover more than 80 percent) at least the one or more heating elements 520 within the one or more recesses 522.

In some instances, the polymer overlay 530 is coupled with the polymer board 510. The polymer overlay 530 for example, is connected with the engagement side 512 of the polymer board 510. In some examples, the polymer overlay 530 is connected with the polymer board 510 with an adhesive, welding, fastener, or the like.

The polymer article assembly 500 is, for example, a component of a flooring system. For instance, the polymer article assembly 500 is a flooring board, tile, slat, or the like. In some examples, the polymer article assembly 500 is a component of an outdoor flooring system, such as a deck, patio, walkway, or the like. In other examples, the polymer article assembly 500 is a component of a structure such as a railing, stairway, or the like. In yet other examples, the polymer article assembly 500 is a component of an article of furniture such a bench, chair, table, or the like).

### ASPECTS

Aspect 1 can include a polymer article assembly comprising: a polymer board having an interior portion and one or more exterior side portions surrounding the interior portion; and at least one heating element including at least one electrical connection portion and the at least one heating element at least partially positioned within the interior portion; wherein the at least one heating element extends within the interior portion.

Aspect 2 can include or can include or can optionally be combined with the subject matter of Aspect 1, to optionally include the at least one at heating element is configured to conduct heat through at least one of the one or more exterior side portions, where the heat conducted towards the at least one of the one or more exterior side portions increases a surface temperature of at least one of the one or more exterior side portions.

Aspect 3 can include or can include, or can optionally be combined with the subject matter of Aspect 1 or 2, to optionally include the at least one electrical connection portion is configured to be coupled with an external source of electricity.

Aspect 4 can include or can include, or can optionally be combined with the subject matter of any of Aspects 1 to 3, to optionally include the at least one heating element extends at least one of longitudinally or laterally within the polymer board.

Aspect 5 can include or can include, or can optionally be combined with the subject matter of any of Aspects 1 to 4 to optionally include the polymer board can include an engagement side and a base side opposed to the engagement side.

Aspect 6 can include or can include, or can optionally be combined with the subject matter of any of Aspects 1 to 5 to optionally include an engagement side and a base side opposed to the engagement side; wherein the one or more heating elements can include at least one heating element; wherein the at least one heating element is positioned within the interior portion closer to the engagement side than to the base side.

Aspect 7 can include or can include, or can optionally be combined with the subject matter of any of Aspects 1 to 6 to optionally include the polymer board can include one or more recesses; wherein the at least one heating element is positioned within the one or more recesses.

Aspect 8 can include or can include, or can optionally be combined with the subject matter of any of Aspects 1 to 7 to optionally include the one or more recesses extending along an engagement side and the one or more recesses extend into an interior portion of the polymer board.

Aspect 9 can include or can include, or can optionally be combined with the subject matter of any of Aspects 1 to 8 to optionally include one or more recesses formed within the polymer board; wherein the at least one heating element is exposed from the one or more recesses.

Aspect 10 can include or can include, or can optionally be combined with the subject matter of any of Aspects 1 to 9 to optionally include an overlay; wherein the overlay is coupled with the polymer board and is configured to cover the one or more heating element.

Aspect 11 can include or can include, or can optionally be combined with the subject matter of any of Aspects 1 to 10 to optionally include the one or more heating elements is positioned within the interior polymer board; wherein portions of the polymer board cover the one or more heating elements.

Aspect 12. can include or can include, or can optionally be combined with the subject matter of any of Aspects 1 to 11 to optionally include wherein the one or more heating elements extend longitudinally along a length of the polymer board.

Aspect 13 can include a base board including an engagement side and a base side; a polymer overlay in communication with the engagement side of the polymer board; wherein the polymer overlay can include an engagement face and a coupling face, the coupling face coupled with the engagement side of the base board; and one or more heating elements positioned relative to the polymer overlay; wherein the one or more heating elements can include at least one electrical connection portion.

Aspect 14 can include or can include, or can optionally be combined with the subject matter of Aspect 13 to optionally include the one or more heating elements can include one or more heating elements; wherein the one or more heating elements is configured to increase the temperature of the engagement face.

Aspect 15 can include or can include, or can optionally be combined with the subject matter of any of Aspects 13 to 14 to optionally include the one or more heating elements is positioned within the polymer overlay.

Aspect 16 can include or can include, or can optionally be combined with the subject matter of any of Aspects 13 to 15 to optionally include the one or more heating elements extends through the polymer overlay.

Aspect 17 can include or can include, or can optionally be combined with the subject matter of any of Aspects 13 to 16 to optionally include the one or more heating elements can include at least one heating element; wherein the at least one electrical connection portion is configured to be electrically coupled with an electrical source.

Aspect 18 can include or can include, or can optionally be combined with the subject matter of any of Aspects 13 to 17 to optionally include the one or more heating elements extends within the polymer overlay.

Aspect 19 can include or can include, or can optionally be combined with the subject matter of any of Aspects 13 to 18 to optionally include the one or more heating elements is positioned between the polymer overlay and the engagement side of the polymer board.

Aspect 20 can include or can include, or can optionally be combined with the subject matter of any of Aspects 13 to 19 to optionally include an intermediate layer positioned between the engagement side and the coupling face; wherein the one or more heating elements is positioned within the intermediate layer.

Aspect 21 can include or can include, or can optionally be combined with the subject matter of any of Aspects 13 to 20 to optionally include the intermediate layer can include an adhesive.

Aspect 22 can include or can include, or can optionally be combined with the subject matter of any of Aspects 13 to 21 to optionally include the polymer board system is a component of an article of furniture.

Aspect 23 can include or can include, or can optionally be combined with the subject matter of any of Aspects 13 to 22 to optionally include the polymer board system is component of one of flooring or decking.

Aspect 24 can include method of forming a temperature-controlled polymer board comprising: positioning one or more temperature-controlled elements along a cavity, the cavity defined by portions of a mold; retaining the one or more temperature-controlled elements at a first end position of the one or more temperature-controlled elements; wherein retaining the one or more temperature-controlled elements maintains the position of the one or more temperature-controlled elements; introducing molten polymer into the cavity of the mold; wherein the molten polymer fills a space within the cavity; covering the one or more temperature-controlled elements with the molten polymer; and retaining the one or more temperature-controlled elements within a set polymer.

Aspect 25 can include or can include, or can optionally be combined with the subject matter of Aspects 24 to optionally include the one or more temperature-controlled elements can include at least one heating elements.

Aspect 26 can include or can include, or can optionally be combined with the subject matter of any of Aspects 24 to 25 to optionally include at least a portion of the one or more temperature-controlled elements is exposed from the set polymer.

Aspect 27 can include or can include, or can optionally be combined with the subject matter of any of Aspects 24 to 26 to optionally include the set polymer can include a polymer overlay, the method including: positioning the polymer overlay relative to a base board, the base board including a base side and an engagement side; and coupling the polymer overlay with the engagement side of the base board.

Aspect 28 can include or can include, or can optionally be combined with the subject matter of any of Aspects 24 to 27 to optionally include the polymer board can include a flooring board.

Aspect 29 can include or can include, or can optionally be combined with the subject matter of any of Aspects 24 to 28 to optionally include the polymer board is a component of an article of furniture.

Aspect 30 can include method of forming a temperature-controlled polymer board comprising: forming a polymer board including an engagement side and a base side; forming one or more recess within the polymer board proximate to the engagement side; and positioning one or more temperature controlling wires within the one or more recess.

Aspect 31 can include or can include, or can optionally be combined with the subject matter of Aspect 30 to optionally include drilling one or more passages through at least a portion of the polymer board.

Aspect 32 can include or can include, or can optionally be combined with the subject matter of any of Aspects 30 to 31 to optionally include forming the polymer board can include: introducing molten polymer into a mold; wherein the mold can include one or more protrusions, the protrusions correspond to one or more recesses; and coupling a polymer overlay on the polymer board.

Each of these non-limiting aspects can stand on its own or can be combined in various permutations or combinations with one or more of the other aspects.

The above description can include references to the accompanying drawings, which form a part of the detailed description. The drawings show, by way of illustration, specific embodiments in which the invention can be practiced. These embodiments are also referred to herein as “aspects” or “examples.” Such aspects or examples can include elements in addition to those shown or described. However, the present inventors also contemplate aspects or examples in which only those elements shown or described are provided. Moreover, the present inventors also contemplate aspects or examples using any combination or permutation of those elements shown or described (or one or more features thereof), either with respect to a particular aspects or examples (or one or more features thereof), or with respect to other Aspects (or one or more features thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” can include “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that can include elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Geometric terms, such as “parallel,” “perpendicular,” “round,” or “square,” are not intended to require absolute mathematical precision, unless the context indicates otherwise. Instead, such geometric terms allow for variations due to manufacturing or equivalent functions. For example, if an element is described as “round” or “generally round,” a component that is not precisely circular (e.g., one that is slightly oblong or is a many-sided polygon) is still encompassed by this description.

Method aspects or examples described herein can be machine or computer-implemented at least in part. Some aspects or examples can include a computer-readable medium or machine-readable medium encoded with instructions operable to configure an electronic device to perform methods as described in the above aspects or examples. An implementation of such methods can include code, such as microcode, assembly language code, a higher-level language code, or the like. Such code can include computer readable instructions for performing various methods. The code may form portions of computer program products. Further, in an aspect or example, the code can be tangibly stored on one or more volatile, non-transitory, or non-volatile tangible computer-readable media, such as during execution or at other times. Aspects or examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described aspects or examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as aspects, examples, or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A polymer article assembly comprising:
a polymer article having an interior portion and one or more exterior side portions surrounding the interior portion; and
at least one heating element including at least one electrical connection portion;
wherein the at least one heating element is at least partially positioned within the interior portion;
wherein the at least one heating element extends from the electrical connection portion within the interior portion of the polymer article.

2. The polymer article assembly of claim 1, wherein the at least one at heating element is configured to conduct heat through at least one of the one or more exterior side portions;
wherein the heat conducted towards the at least one of the one or more exterior side portions increases a surface temperature of at least one of the one or more exterior side portions.

3. The polymer article assembly of claim 1, wherein the at least one electrical connection portion is configured to be coupled with a source of electricity.

4. The polymer article assembly of claim 1, wherein the at least one heating element extends at least one of longitudinally or laterally within the polymer article.

5. The polymer article assembly of claim 1, wherein the polymer article can include an engagement side and a base side opposed to the engagement side.

6. The polymer article assembly of claim 1, including an engagement side and a base side opposed to the engagement side;
wherein the at least one heating element is positioned within the interior portion closer to the engagement side than to the base side.

7. The polymer article assembly of claim 1, wherein the polymer article can include one or more recesses formed within one of the one or more exterior side portions or within the interior portion;
wherein the at least one heating element is positioned within the one or more recesses.

8. The polymer article assembly of claim 7, wherein the one or more recesses extend from the one or more exterior side portions into an interior portion of the polymer article.

9. The polymer article assembly of claim 7, including one or more recesses formed within the interior portion of polymer article;
wherein the at least one heating element is exposed from the one or more recesses.

10. The polymer article assembly of claim 1, including an overlay;
wherein the overlay is a polymer overlay coupled with the polymer article and the polymer overlay is configured to cover the one or more heating element.

11. The polymer article assembly of claim 1, wherein the one or more heating elements is positioned within the interior polymer article;
wherein the one or more heating elements are surrounded by the interior portion.

12. The polymer article assembly of claim 1, wherein the one or more heating elements extend longitudinally along a length of the polymer article.

13. A polymer overlay comprising:
an elongate polymer article including:
an engagement face configured to face an exterior; and
a coupling face configured to couple along a board; and
one or more heating elements coupled with the polymer overlay;
wherein the one or more heating elements can include at least one electrical connection portion.

14. The polymer overlay of claim 13, wherein the one or more heating elements can include a first heating element and a second heating element;
wherein the one or more heating elements are configured to increase a temperature of the engagement face.

15. The polymer overlay of claim 13, wherein the one or more heating elements is positioned within the elongate polymer article.

16. The polymer overlay of claim 13, wherein the one or more heating elements extends through the elongate polymer article.

17. The polymer overlay of claim 13, wherein the one or more heating elements can include at least one heating element;
wherein the at least one electrical connection portion is configured to be electrically coupled with an electrical source.

18. A temperature-controlled polymer article assembly comprising:
a base board including an engagement side and a base side;
a polymer overlay coupled along the engagement side of the base board the polymer overlay can include:
an engagement face; and
a coupling face coupled with the engagement side of the base board; and one or more heating elements positioned relative to the polymer overlay;
wherein the one or more heating elements can include at least one electrical connection portion.

19. The temperature-controlled polymer article assembly of claim 18, wherein the one or more heating elements are configured to increase a temperature of the engagement face.

20. The temperature-controlled polymer article assembly of claim 18, wherein the one or more heating elements is positioned within the polymer overlay.

21. The temperature-controlled polymer article assembly of claim 18, wherein the one or more heating elements extend through the polymer overlay.

22. The temperature-controlled polymer article assembly of claim 18, wherein the at least one electrical connection portion is configured to be electrically coupled with an electrical source.

23. The temperature-controlled polymer article assembly of claim 18, wherein the one or more heating elements extends within the polymer overlay.

24. The temperature-controlled polymer article assembly of claim 18, wherein the one or more heating elements is positioned between the polymer overlay and the engagement side of the base board.

25. The temperature-controlled polymer article assembly of claim 18, including an intermediate layer positioned between the engagement side and the coupling face;
wherein the one or more heating elements are positioned within the intermediate layer.

26. The temperature-controlled polymer article assembly of claim 25, wherein the intermediate layer can include an adhesive.

27. The temperature-controlled polymer article assembly of claim 18, wherein the polymer article is a component of an article of furniture.

28. The temperature-controlled polymer article assembly of claim 18, wherein the polymer article is a linearly extending component of one of flooring or decking.

29. A method of forming a temperature-conditioned polymer article comprising:
positioning one or more temperature-conditioning elements along a cavity, the cavity defined by portions of a mold;
retaining the one or more temperature-conditioning elements at a first end position of the one or more temperature-conditioning elements;
wherein retaining the one or more temperature-conditioning elements maintains the position of the one or more temperature-conditioning elements; introducing molten polymer into the cavity of the mold;
wherein the molten polymer fills a space within the cavity;
covering the one or more temperature-conditioning elements with the molten polymer; and
retaining the one or more temperature-conditioning elements within a set polymer.

30. The method of forming the temperature-conditioned polymer article of claim 29, wherein the one or more temperature-conditioning elements can include at least one heating elements.

31. The method of forming the temperature-conditioned polymer article of claim 29, wherein at least a portion of the one or more temperature-conditioning elements is exposed from the set polymer.

32. The method of forming the temperature-conditioned polymer article of claim 29, wherein the set polymer can include a polymer overlay, the method including:
positioning the polymer overlay relative to a base board, the base board including a base side and an engagement side; and
coupling the polymer overlay with the engagement side of the base board.

33. The method of forming the temperature-conditioned polymer article of claim 29, wherein the polymer article can include a flooring board.

34. The method of forming the temperature-conditioned polymer article of claim 29, wherein the polymer article is a component of an article of furniture.

35. A method of forming a temperature-conditioned polymer board comprising:
forming a polymer board including an engagement side and a base side;
forming one or more recess within the polymer board proximate to the engagement side; and
positioning one or more heating elements within the one or more recess.

36. The method of forming the temperature-conditioned polymer board of claim 35 can include:
drilling one or more passages through at least a portion of the polymer board.

37. The method of forming the temperature-conditioned polymer board of claim 35, wherein forming the polymer board can include:
introducing molten polymer into a mold;
wherein the mold can include one or more protrusions, the protrusions correspond to one or more recesses; and
coupling a polymer overlay on the polymer board.
